(19) United States
(12) Patent Application Publication
(10) Pub. No.: US 2018/0252015 A1
(43) Pub. Date: Sep. 6, 2018

(54) DOOR CLOSING DEVICE WITH MULTI-RATIO RACK AND PINION

(71) Applicant: HAMPTON PRODUCTS INTERNATIONAL CORPORATION, Foothill Ranch, CA (US)

(72) Inventors: Jason L. Quinn, Spooner, WI (US); Lucas J. Stanton, Stone Lake, WI (US)

(73) Assignee: HAMPTON PRODUCTS INTERNATIONAL CORPORATION, Foothill Ranch, CA (US)

(21) Appl. No.: 15/908,195

(22) Filed: Feb. 28, 2018

Related U.S. Application Data
(60) Provisional application No. 62/465,614, filed on Mar. 1, 2017.

(51) Int. Cl. E05F 3/10; E05F 1/10

(52) U.S. Cl. CPC E05F 3/102; E05F 1/105; E05Y 2900/132; E05Y 2201/722; E05Y 2201/25; E05Y 2201/41

(57) ABSTRACT

A door-closing device connectable by a linkage assembly between a door and a door frame includes a piston linearly movable between a door-open position and a door-closed position toward which the piston is biased. The piston has first and second sets of rack teeth disposed thereon. A pinion gear is mounted on a rotatable shaft coupled to the linkage assembly, the pinion gear having a first set of gear teeth along a first circumferential portion for engagement with the first set of rack teeth, and a second set of gear teeth along a second circumferential portion for engagement with the second set of rack teeth, the engagement between the first set of pinion gear teeth and the first set of rack teeth providing a first gear ratio, and the engagement of the second set of pinion gear teeth with the second set of rack teeth providing a second gear ratio.

### CROSS-REFERENCE TO RELATED APPLICATION

This application claims priority, under 35 U.S.C. § 119(e), from U.S. Provisional Application No. 62/465,614, filed Mar. 1, 2017, the disclosure of which is incorporated herein by reference in its entirety.

### FEDERALLY SPONSORED RESEARCH OR DEVELOPMENT

Not Applicable.

### BACKGROUND

The present disclosure relates generally to door closing devices. More particularly, the disclosure relates to door closing devices having rack and pinion mechanisms.

Many commercial and residential doors include an automatic closing mechanism, whereby the door is automatically closed after it has been opened. Typically, the door is attached to the door frame by an articulated linkage assembly comprising a first linkage arm and second linkage arm, each joined at one end to a pivot joint. The end of the first arm opposite the joint is rotatably connected to the automatic door closing mechanism, while the end of the second arm opposite the joint is pivotably mounted to the door frame. When the door is opened and released, the door closing mechanism imparts a rotational force to the first linkage arm, whereby the first linkage arm rotates the pivot joint to impart a closing motion to the door through the second linkage arm.

In some instances, the automatic closing mechanism relies on a compression spring to provide the mechanical force to close an opened door. The mechanism operates by a movable piston mechanically connected to the first arm. The piston abuts the spring and compresses it as the door is opened. When the door is released, the spring decompresses to return to its natural state, pushing the piston linearly in a direction that actuates the arm assembly, by means of the connection between the piston and the first arm, to close the door. A rack and pinion gearing system is often used to convert the linear motion of the piston into a rotary motion of the first arm that translates into the pivoting action of the arm assembly. Typically, the rack gear is attached to the piston, and the pinion gear is coupled to the first arm of the door closing mechanism. When the door is opened, the arm rotates the pinion gear, which then drives the rack gear to move linearly in a direction compressing the spring. When the door is released, the stored energy in the compression spring drives the piston to move linearly, thereby causing the pinion gear to rotate to automatically close the door.

Because the door closing mechanism relies on a compression spring to provide the force necessary to close the door, a user must apply a force large enough to compress the spring in order to open the door to a desired angle. The required opening force may be difficult to exert for some people. For example, certain requirements of the Americans with Disabilities Act (ADA) specify a maximum door opening force of less than 5 pounds. Likewise, a person carrying a child or a package may find it difficult to open the door. At the same time, the automatic door closing mechanism must provide a sufficient, consistent, and reliable closing force to securely latch the door in the closed position.

### SUMMARY

For purposes of summarizing the disclosure, exemplary concepts have been described herein. It is to be understood that not necessarily all such concepts may be achieved in accordance with any particular embodiment. Thus, for example, those skilled in the art will recognize that embodiments may be carried out in a manner that achieves or optimizes one concept as taught herein without necessarily achieving other concepts as may be taught or suggested herein.

As described in more detail below, the subject matter disclosed herein provides, in one aspect, a door closing mechanism or device having a rack and pinion gear system with more than one gear ratio (multi-ratio rack and pinion) to reduce the force required to open the door while providing a sufficient closing force to latch the door in the fully closed and latched condition.

More specifically, a door closing mechanism or device according to an embodiment of this disclosure is configured to be mounted on a door for connection to an articulated door closing arm assembly, as described above. The device or mechanism, in accordance with aspects of the disclosure, includes a housing, a pinion gear within the housing and connected to a rotary shaft configured to be coupled to an end of the first arm of the articulated door closer arm assembly, and a spring-loaded piston movable linearly in the housing and including a rack gear engaging the pinion gear. In accordance with aspects of this disclosure, the pinion gear has at least first and second circumferential regions, with first and second sets of pinion gear teeth, respectively. The first set of pinion gear teeth has a first gear radius and a first circumferential pitch, and the second set of pinion gear teeth has a second gear radius and a second circumferential pitch, wherein the second gear radius and the second circumferential pitch are smaller than the first gear radius and the first circumferential pitch, respectively. Similarly, the rack has a first linear region with a first linear set of rack teeth having a first linear pitch, and a second linear region having a second linear set of rack teeth having a second linear pitch smaller than the first linear pitch. Engagement of the pinion gear teeth in the first circumferential region with the rack teeth in the first linear region provides a first gear ratio that increases the closing force applied by the closing mechanism to move the door to a fully closed position from a partially-closed position, and to latch the door in the fully closed position. Engagement between the pinion gear teeth in the second circumferential region with the rack teeth in the second linear region provides a second gear ratio that allows the door to open with less force from a partially-closed position to the open position than would be provided by a larger gear ratio.

In some embodiments, the first and second circumferential regions of the pinion gear are in the same axial plane, and the first and second linear regions are in a single plane on a single rack. In other embodiments, the first and second circumferential regions of the pinion gear are axially offset (i.e., in first and second distinct axial planes). In these embodiments, the first linear region of rack teeth is on a first rack aligned with the first axial plane, and the second linear region of rack teeth is on a second rack, parallel to the first rack, and aligned with the second axial plane. In both embodiments, the pinion gear teeth in the first circumferential region engage only rack teeth in the first linear region, and the pinion gear teeth in the second circumferential region engage only rack teeth in the second linear region. Either embodiment can be straightforwardly modified to include three of more circumferential regions and an equal number of linear regions, thereby yielding three or more gear ratios.

In another aspect, this disclosure relates to an automatic door-closing mechanism for a door-closing device of the type including a linearly-movable piston with multiple (i.e., two or more) gear ratios movable between a door-closed position and a door-open position relative to a door frame, wherein the piston is biased toward the door-closed position. The piston is movable using a first gear ratio when the door is initially opened to a predetermined partially open position and when the door is about to be fully closed in a latched condition. The piston is movable using a second gear ratio when the door is moved from the partially open position to a fully open position, and from the fully open position to the partially open position.

In yet another aspect, this disclosure relates to an automatic door-closing mechanism for a door-closing device having a multiple force capability, the mechanism including a linearly-movable piston with different door opening and door closing forces.

In still another aspect, this disclosure relates to a method of closing a door automatically, comprising opening the door using a rack-and-pinion gear assembly having a first gear ratio used for the initial opening and final closing, and using a second gear ratio for movement of the door between a partially open position and a fully open position.

These and other aspects and embodiments will become apparent to those skilled in the art from the following detailed description of the various embodiments having reference to the attached figures, the disclosure not being limited to any particular embodiment.

### BRIEF DESCRIPTION OF THE DRAWINGS

FIG. 1 is an elevation external view of an automatic door closing device or mechanism, as installed on a door, wherein the mechanism is connected to a door frame or door jamb by an articulated or pivotable linkage arm assembly.

FIG. 2 is a longitudinal cross-sectional view of an embodiment of a multi-ratio rack-and-pinion door closing device in accordance with one embodiment of the disclosure, showing the rack-and-pinion assembly when the door closing device is in a “door closed” position.

FIG. 3 is a close-up longitudinal cross-sectional view of the rack-and-pinion assembly of FIG. 2, showing the positions of the rack and pinion gears when the door is closed.

FIG. 4 is a perspective view of an alternative embodiment of a rack-and-pinion assembly in accordance with this disclosure;

FIG. 5 is a close-up longitudinal cross-sectional view of the rack-and-pinion assembly of FIG. 2, showing a transition from engagement between a first set of pinon teeth and a first set of rack teeth to engagement between a second set of pinion teeth and a second set of rack teeth, as the door opens in a door opening direction.

FIG. 6 is a close-up longitudinal cross-sectional view of the rack-and-pinion assembly of FIG. 2, showing the second set of pinion teeth fully engaged with the second set of rack teeth.

FIG. 7 is a close-up longitudinal cross-sectional view of the rack-and-pinion assembly of FIG. 2, showing the pinion transitioning from engagement between the second set of pinion teeth and the second set of rack teeth back to engagement between the first set of pinion teeth and the second set of rack teeth as the door is about to close in a door closing direction.

### DETAILED DESCRIPTION

Exemplary embodiments will now be described with reference to the accompanying figures, wherein like reference numbers refer to like elements throughout. The terminology used in the description presented herein is not intended to be interpreted in any limited or restrictive manner simply because it is being utilized in conjunction with a detailed description of certain embodiments. Furthermore, various embodiments (whether or not specifically described herein) may include novel features, no single one of which is solely responsible for its desirable attributes or which is essential to practicing any of the embodiments herein described.

The present disclosure relates generally to a door closing device, and more particularly to a door closing mechanism including, among other things, a housing, a pinion gear rotatably mounted in the housing and having two or more circumferentially-separated sets of pinion teeth, with each set of pinion teeth having a different gear radius and pitch, a piston disposed slidably in the housing and movable linearly between a door-closed position and a door-open position, a biasing element urging the piston toward the door-closed position, and a rack connected to the piston and having at least first and second linear regions, each with a set of rack teeth, with each set of rack teeth having a different linear pitch. The first set of pinion gear teeth is engageable with a first set of rack teeth in the first linear region, and the second set of pinion gear teeth is engageable with a second set of rack teeth in the second linear region, whereby the door is first moved relatively rapidly to a partially closed position from an open position without additional manipulation upon the release of the door in the open position, and whereby the door is then moved to a fully closed and latched position.

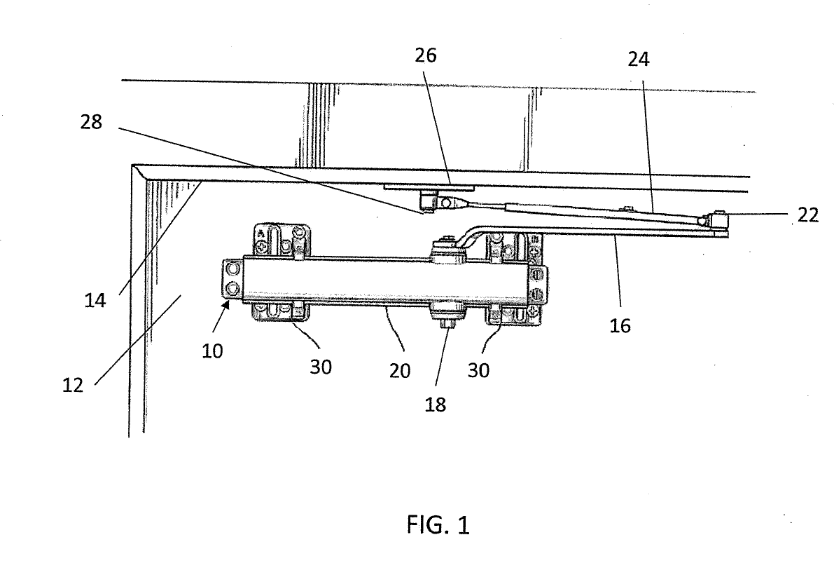

FIG. 1 shows a door closing device or mechanism 10 installed on a door 12 and connected to a door frame or jamb 14 by an articulated or pivoting linkage arm assembly. The linkage arm assembly comprises a first linkage arm 16 having a first end operably connected to a rotatable shaft 18 that extends laterally through a hollow housing or case 20 of the door-closer mechanism 10, and a second end connected by a pivot or hinge 22 to the first end of a second linkage arm 24. The second end of the second linkage arm 24 is rotatably connectable to a bracket 26 on the door frame or jamb 14 by a rotating link 28. The hollow housing or case 20 is fixed to the door 12 by suitable mounting brackets 30.

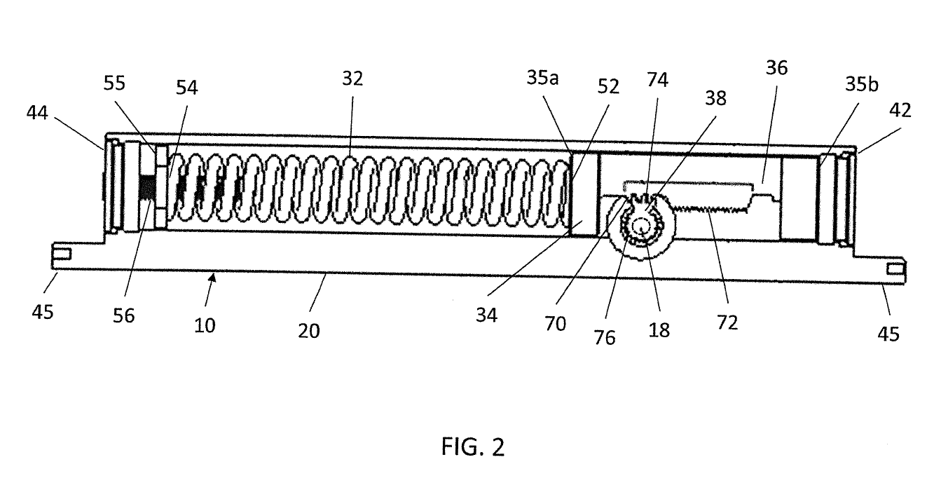

FIG. 2 illustrates the interior of the housing 20, showing the functional components of a door closing device or mechanism 10 in accordance with an embodiment of the present disclosure. The mechanism 10 includes a biasing element, preferably (but not necessarily) a coil spring 32, arranged longitudinally within the housing 20, with a first end engaging a first face of a piston 34 that is movable linearly within the housing 20. The biasing element or spring 32 thus applies a biasing force on the piston 34, which, as discussed below, urges the door 12 toward a closed position. The piston 34 has a first end 35a against which one end of the biasing element or spring 32 engages, and a second end 35b opposite the first end 35a. At least one linear rack gear 36 is formed or provided on the piston 34 between the first end 35a and the second end 35b. The rack gear 36 may be integral with the piston 34, or it may be a separate component fixed to the piston 34.

A pinion gear 38 is provided on the rotatable shaft 18 so as to rotate therewith. The shaft 18 is pivotably coupled to the linkage arm assembly, as described above, so that rotation of the first linkage arm 16 rotates the shaft 18 and the pinion gear 38, and rotation of the pinion gear 38 rotates the first linkage arm 16 through the shaft 18. In some embodiments, the pinion gear 38 is integral with the shaft 18, while in other embodiments, the pinion gear 38 may have an opening extending through which the shaft 18 extends axially for attachment to the first end of the first linkage arm 16. The pinion gear 38 is located on the shaft 18 so as to engage the rack gear 36, as described below.

The housing 20 has a first end 42 and a second end 44 opposite the first end 42. The housing 20 may advantageously include mounting flanges 45 extending from the first and second ends 42, 44 thereof, with through holes for securing the housing 20 to a mounting surface on the door 12, preferably by means of the brackets 30 (FIG. 1). The brackets 30 may be configured to allow the door closing device 10 to slide inside the brackets 30 to accommodate positioning error and tolerance stack-ups.

The biasing element or spring 32 is disposed within the housing 20, and, as mentioned above, is configured to bias the piston 34 towards a door-closed position, which in this embodiment, is toward the first end 42 of the housing 20. More specifically, the biasing element or spring 32 may have a first end 52 urging the piston 34 toward the first end 42 of the housing 20, and a second end 54 engaged against the second end 44 of the housing 20. As the door 12 is opened, the piston 34 is moved toward the second end 44 of the housing 20, thereby compressing the biasing element 32 to store potential energy in it. When the door 12 is released, the biasing element 32 releases the stored energy to urge the piston 34 towards the first end 42 of the housing 20 to close the door.

In some embodiments, the second end 54 of the biasing element 32 may engage a movable backing element 55 configured to preload the biasing element 32. The position of the backing element 55 can be adjusted by an adjustment mechanism, such as, for example, a set screw 56. As shown, the set screw 56 extends through the second end 44 of the housing 20 to engage a threaded hole (not shown) of the backing element 55, such that the set screw 56 can be rotated to move the backing element 55 toward or away from the second end 44 of the housing 20 to adjust the preload on the biasing element 32. For example, the backing element 55 can be adjusted toward the piston 34, thereby compressing the biasing element 32 to increase the force required to open the door and compress the biasing element 32 further.

The piston 34 is configured to slide linearly inside the housing 20 in a longitudinal direction, i.e., along the axis of the housing 20. The outer dimension of the piston 34 may advantageously, but not necessarily, closely match the interior dimensions of the housing 20. As shown, the piston 34 is generally cylindrical in shape, but other shapes may be suitable. In the illustrated embodiment, the first end 35a of the piston 34 faces the second end 44 of the housing 20, and the second end 35b of the piston 34 faces the first end 42 of the housing 20. At least one rack gear 36 configured to engage with the pinion gear 38 extends longitudinally between the first and second ends 35a, 35b of the piston 34, as mentioned above, in a direction parallel to the axis of the housing 20. In the illustrated embodiment, a single rack gear 36 is shown, wherein the rack gear 36 has a first linear region with a first set of rack teeth 70, and a second linear region with a second set of rack teeth 72. The first set of rack teeth 70 has a first linear pitch, and the second set of rack teeth 72 has a second linear pitch smaller than the first linear pitch. Thus, in the illustrated embodiment, the single rack 36 has rack teeth of two different linear pitches in a co-linear and co-planar arrangement. The first set of rack teeth 70 is disposed in a first linear region closer to the first end 35a of the piston 34, and the second set of rack teeth 72 is disposed in a second linear region closer to the second end 35b of the piston 34, wherein the second set of rack teeth 72 includes teeth of smaller size and pitch than the rack teeth in the first set of rack teeth 70.

The pinion gear 38, which engages with the rack gear 36, may be generally cylindrical in shape, with at least first and second circumferential regions or segments respectively provided with a first set of pinion gear teeth 74 and a second set of pinion gear teeth 76. The pinion gear 38 rotatably engages the rack 36, so that rotation of the pinion gear 38 results in linear movement of the piston 34 within the housing 20. Thus, when the door 12 is opened, the rotation of the pinion gear 38 by the linkage arm assembly coupled to the pinion gear 38, translates into a linear motion of the rack 36, thereby moving the piston 34 linearly against the spring force of the biasing element 32. When the door 12 is released from the open position, the return spring force transmitted from the biasing element 32 effects linear movement of the piston 34 and thus of the rack 36, thereby rotating the pinion gear 38 and pivoting the linkage arm assembly coupled to the pinion gear 38 (via the shaft 18) to close the door.

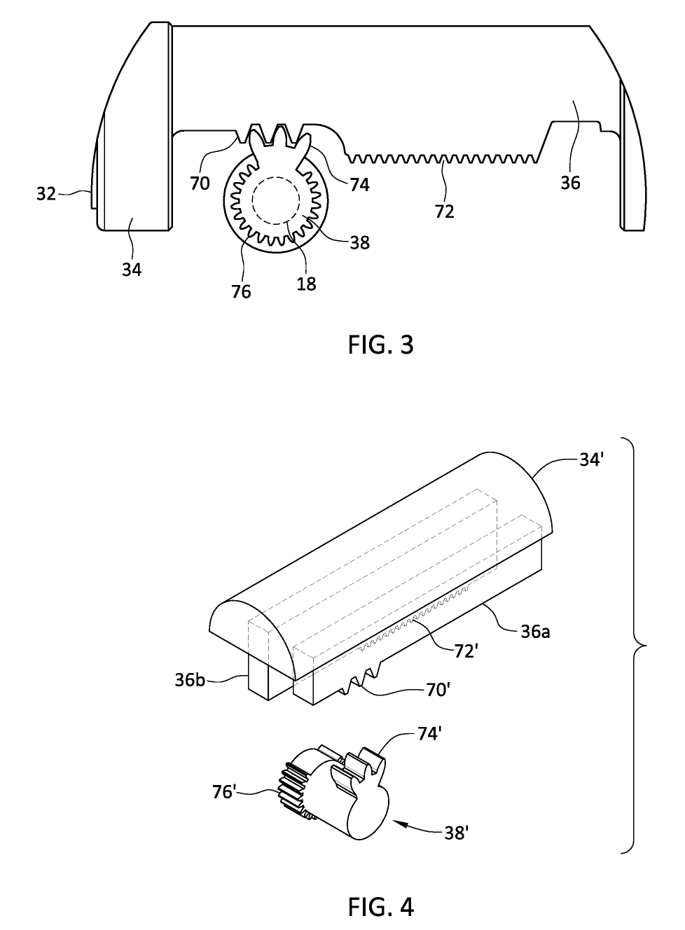

In the embodiment shown in FIG. 3, the first set of pinion gear teeth 74 is located at a first circumferential region of the pinion gear 38, and the second set of pinion gear teeth 76 is located at a second circumferential region of the pinion gear 38. The first and second sets of pinion gear teeth 74, 76 are configured to engage respectively with corresponding first and second sets of rack teeth 70, 72 provided on the piston 34, as discussed in detail below. Although the illustrated embodiment shows two sets of pinion gear teeth, the number of sets of pinion gear teeth can vary to correspond to the number of sets of rack gear teeth on the piston 34. If the sets of rack teeth are in different linear regions of a single rack (i.e., the sets of the rack teeth are coplanar) the different sets of pinion gear teeth would advantageously be at the same axial position along the length of the pinion gear 38. If the sets of rack teeth are on two or more laterally-offset and parallel racks (as described below), the sets of pinion gear teeth are advantageously located at respective axial positions along the length of the pinion gear 38, so as to engage with the corresponding sets of rack teeth.

The teeth in the first set of pinion gear teeth 74 have a first size, gear radius, and circumferential pitch, while the teeth in the second set of pinion gear teeth 76 have a second size, gear radius, and circumferential pitch, each of which is less than the corresponding dimension of the teeth in the first set of pinion gear teeth 74. The gear radii of both the first and second sets of pinion gear teeth are advantageously measured from the same center, namely, the axis of rotation of the pinion gear 38. The engagement of the first set of pinion gear teeth 74 with the first set of rack teeth 70 provides a first gear ratio that provides a larger mechanical advantage to compress the biasing element or spring 32 as the door is opened to a partially open position from a fully closed position. That is, the larger gear radius or gear ratio of the first set of pinion gear teeth 74 allows a greater axial movement of the rack 36 for each degree of rotation of the pinion gear 38 than does the second set of pinion gear teeth 76, thereby moving the door more quickly. For closing the door, the larger gear radius or gear ratio of the first set of pinion gear teeth 74 also provides a larger mechanical advantage to transmit a force from the decompressing of the biasing element or spring 32 sufficient to move the door to a fully closed and latched position from a partially closed position. Despite the larger gear radius of the first set of pinion gear teeth 74 relative to the second set of pinion gear teeth 76, the difference in the force F (wherein F=k*Δx, k is the spring constant of the spring 32 and Δx=change in displacement or compression of the spring 32) required to open the door partially is not significantly greater than with the smaller pitch diameter of the second set of pinion gear teeth 76, because there is little or no compression of the biasing element or spring 32 when the door is at its fully closed position, and thus only a moderate force, at most, is needed to move the door to a partially-opened position. When the second set of pinion gear teeth 76 engages the second set of rack teeth 72, as explained in further detail below, although the force required to compress the spring 32 increases because of the increased compression of the spring 32 from its initial state, the smaller gear radius or gear ratio of the second set of pinion gear teeth 76 allows the door to be moved from the partially open to the fully open position more easily, i.e., with less opening force, than with a larger gear radius or gear ratio.

When it is desired to close the door, the second gear ration provided by the engagement between the second set of pinion gear teeth 76 with the second set of rack teeth 72 allows the door, when released from the open position, to begin to close relatively slowly as the biasing element or spring 32 decompresses. This relatively slower movement occurs until the door is nearly, but not fully, closed, at which point the first set of pinion gear teeth 74 begins to re-engage with the first set of rack teeth 70, thereby once again providing the first gear ratio that facilitates full door closing at a higher force and quicker movement, as mentioned above.

Other embodiments may include two or more racks, wherein each individual rack has a single set of rack teeth of a unique pitch compared to the teeth on the other rack(s), whereby the pitch of the rack teeth is different for each of the racks. In FIG. 4, for example, first and second linear rack gears 36a and 36b may be formed or provided on a piston 34′, so as to be laterally offset from each other and generally parallel to each other. The first rack gear 36a has a first set of rack teeth 70′ in a first linear region of the first rack gear 36a, and the second rack gear 36b has a second set of rack teeth 72′ that is longitudinally offset from the first set of rack teeth 70′. The first set of rack teeth 70′ has a relatively large pitch, while the second set of rack teeth 72′ has a larger pitch. The first and second rack gears 36a, 36b are respectively engageable with a first set of pinion gear teeth 74′ and a second set of pinion gear teeth 76′ provided at axial positions on a cylindrical pinion gear 38′ that respectively correspond to the positions of the first and second racks 36a, 36b. Other than being displaced from each other axially along the length of the pinion gear 38′, the first and second sets of pinion gear teeth 74′ and 76′ may be substantially similar to their counterparts in the above described embodiment of FIG. 3. Thus, the first set of pinion gear teeth 74′, with a larger pitch radius, will engage with the corresponding first set of rack teeth 72′, and the second set of pinion gear teeth 76′, with a smaller pitch radius, will then engage with second set of rack teeth 72′ as the pinion gear 38′ is rotated, as described above with respect the embodiment of FIG. 3.

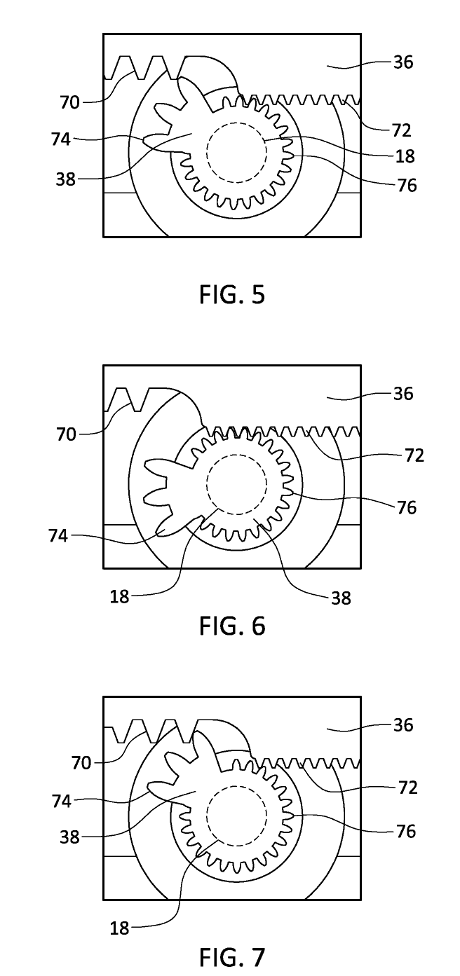

FIGS. 3 and 5-7 illustrate various stages of engagement between the pinion gear 38 and the rack 36. FIG. 3 illustrates the door closing device 10 with a door in the closed position. As shown, the first set of pinion gear teeth 74 is fully engaged with the first set of rack teeth 70. The engagement between the first sets of teeth 70, 74 provides a first, relatively large gear ratio that moves the door more quickly to a partially open position, as discussed above. FIG. 5 illustrates the transition of the second set of pinion gear teeth 76 into engagement with the second set of rack teeth 72 as the door is partially opened. At this point, the biasing element or spring 32 (FIG. 2) is compressed, so that, if the door is released from the open position shown in FIG. 5, the door will be urged toward the closed position by the decompression of the biasing element or spring 32. FIG. 6 illustrates the door closing device with the door in a partially or fully open position, with the second set of pinion gear teeth 76 fully engaged with the second set of rack teeth 72. As long as the second set of pinion teeth 76 is engaged with the second set of rack teeth 72, by decompression of the spring 32, the door will close relatively slowly, owing to the second and smaller gear ratio provided by the second sets of teeth 72, 76. When the door is returned to a partially-closed position, the first sets of gear teeth 70, 74 begin to re-engage, as shown in FIG. 7. When the first set of pinion gear teeth 74 re-engage with the first set of rack teeth 70, the first and relatively larger gear ratio is again provided, thereby increasing the force applied to the piston 34 to close and latch the door securely.

From the foregoing, it can be appreciated that the engagement between the first set of pinion gear teeth 74 and the first set of rack teeth 70 provides a first gear ratio, and occurs when the door is closed, as shown in FIG. 3, until a predetermined partially open door position is achieved, as shown in FIG. 5. This may also be defined as the first gear ratio range. Because of the larger gear radius of the first set of pinion gear teeth 74 relative to the second set of pinion gear teeth 76, enough closing force can be provided by the biasing element 32 to sufficiently close the door to the latched position. Said differently, the gear radius of the first set of pinion gear teeth 74 is sized to allow the biasing element 32 to provide a sufficient closing force to close the door to the latched position.

The engagement between the second set of pinion gear teeth 76 and the second set of rack teeth 72, which provides a second gear ratio, occurs when the door is opened past the predetermined door closing position, as illustrated in FIG. 6, and up to a transition point at which the first set of pinion gear teeth 74 is about to contact the first set of rack teeth 70, as shown in FIG. 7. This may also be defined as the second gear ratio range. Because of the smaller gear radius of the second set of pinion gear teeth 76 relative to the first set of pinion gear teeth 74, further opening of the door past the predetermined opening position requires less force than when the first set of pinion gear teeth 74 are engaged with the first set of rack teeth 70. Thus, the door closing device 10 has two (or, in some embodiments, more than two) gear ratios to control the forces necessary to open and close the door. Thus, the first gear ratio is used for the initial opening of the door from the closed position to a defined partially-open position, and for the final, latching portion of the door closing cycle. The second gear ratio is used for opening the door from the defined partially open position to its open or fully open position, and for closing the door from the fully open position up until the final latching portion of the door closing cycle.

The distance between the innermost location of the first set of rack teeth 70 and the second set of rack teeth 72, respectively, can be determined using the respective arc lengths of the circumferential segments occupied by the first set of pinion gear teeth 74 and the second set of pinion gear teeth 76 to provide a smooth, synchronized transition between the engagement or disengagement of the first set of pinion gear teeth 74 with the first set of rack teeth 70, and with the second set of pinion gear teeth 76 and the second set of rack teeth 72, respectively. Furthermore, the transition between racks can be abrupt to have an immediate change, or smooth to have a gradual change in forces applied to or from the door closing device 10.

As discussed above, the linear regions of the rack or racks can be coplanar (i.e., on a single rack), or longitudinally offset from, and parallel to, each other (i.e., two or more racks). In embodiments in which the respective linear regions of the racks are longitudinally offset to each other on parallel planes, the racks can be arranged such that the pinion gear does not interfere with the other racks when engaged with one rack. Alternatively, the pinion gear may engage with multiple racks simultaneously.

Although exemplary embodiments of the disclosure are illustrated and described herein, a number of variations and modifications will make themselves apparent to those skilled in the art. For example, instead of a coil spring as the biasing element, a pneumatic cylinder may be used, as is well-known in the art. The piston would then be modified (in a manner that would readily suggest itself to those of ordinary skill in the art) so that it would be suitably biased by pneumatic pressure within the cylinder. These and other variations and modifications are understood as being encompassed within the spirit and scope of the disclosed subject matter, and all such changes and modifications are intended to be encompassed within the appended claims.

What is claimed is:

1. A door-closing device configured to be connected by an articulated linkage arm assembly between a door and a door frame so as to bias the door from an open position toward a closed position, the door-closing device comprising:
a piston having first and second ends, the piston being movable linearly between a door-open position and a door-closed position;
at least first and second sets of rack teeth arranged linearly along the piston between the first and second ends of the piston;
a biasing element engageable with the piston so as to bias the piston toward the door-closed position; and
a pinion gear mounted on a rotatable shaft coupled to the articulated linkage arm assembly, the pinion gear having a first set of pinion gear teeth along a first circumferential portion of the pinion gear and configured to engage the first set of rack teeth, and a second set of pinion gear teeth along a second circumferential portion of the pinion gear and configured to engage the second set of rack teeth, the first set of pinion gear teeth having a first gear radius and the second set of pinion gear teeth having a second gear radius.

2. The door-closing device according to claim 1, wherein the first and second sets of rack teeth are generally coplanar.

3. The door-closing device according to claim 1, wherein the second set of rack teeth is generally parallel to and laterally offset from the first set of rack teeth.

4. The door-closing device of claim 1, wherein the first and second sets of rack teeth have different linear pitches.

5. The door-closing device of claim 4, wherein the first set of rack teeth has a first linear pitch, and the second set of rack teeth has a second linear pitch smaller than the first linear pitch.

6. The door closing device of claim 1, wherein the second gear radius is smaller than the first gear radius.

7. The door closing device of claim 6, wherein the first set of rack teeth has a first linear pitch and the second set of rack teeth has a second linear pitch smaller than the first linear pitch.

8. The door closing device of claim 6, wherein the pinion gear has an axis of rotation, and wherein the first gear radius and the second gear radius are both measured from the axis of rotation.

9. A method of opening and closing a door connected to a door frame by an articulated linkage arm assembly, comprising:
providing a gear assembly connecting the door to the articulated linkage arm assembly, the gear assembly having a first gear ratio and a second gear ratio;
opening the door from a closed position to a defined partially open position against a biasing force using the first gear ratio;
opening the door from the partially open position to a fully open position against the biasing force using a second gear ratio;
closing the door from the fully open position to the partially open position using the second gear ratio; and
closing the door from the partially open position to the closed position using the first gear ratio.

10. The method of claim 9, wherein the gear assembly comprises:
a first set of pinion gear teeth engageable with a first set of rack teeth to provide the first gear ratio; and
a second set of pinion gear teeth engageable with a second set of rack teeth to provide the second gear ratio.

11. The method of claim 10, wherein the first and second sets of pinion gear teeth are provided on a pinion gear that is rotated by the linkage arm assembly as the door is moved between the closed position and the fully open position.

12. The method of claim 11, wherein the first set of pinion gear teeth are located on a first circumferential portion of the pinion gear, and the second set of pinion gear are located on a second circumferential portion of the pinion gear.

13. A door-closing device configured to be connected by an articulated linkage arm assembly between a door and a door frame so as to bias the door from an open position toward a closed position, the door-closing device comprising:
a piston disposed for linear movement between a door-open position and a door-closed position, the piston being biased toward the door-closed position;
first and second sets of rack teeth on the piston, wherein the first set of rack teeth and the second set of rack teeth are arranged linearly; and
a pinion gear mounted on a rotatable shaft coupled to the articulated linkage arm assembly, the pinion gear having a first set of pinion gear teeth along a first circumferential portion of the pinion gear and configured to engage the first set of rack teeth, and a second set of pinion gear teeth along a second circumferential portion of the pinion gear and configured to engage the second set of rack teeth, the engagement between the first set of pinion gear teeth and the first set of rack teeth providing a first gear ratio, and the engagement of the second set of pinion gear teeth with the second set of rack teeth providing a second gear ratio.

14. The door-closing device according to claim 13, wherein the first and second sets of rack teeth are generally coplanar.

15. The door-closing device according to claim 13, wherein the second set of rack teeth is parallel to and laterally offset from the first set of rack teeth.

16. The door-closing device of claim 13, wherein the first set of pinion gear teeth has a first gear radius and the second set of pinion gear teeth has a second gear radius smaller than the first gear radius.

17. The door-closing device of claim 16, wherein the first set of rack teeth has a first linear pitch, and the second set of rack teeth has a second linear pitch smaller than the first linear pitch.

18. The door closing device of claim 16, wherein the pinion gear has an axis of rotation, and wherein the first gear radius and the second gear radius are both measured from the axis of rotation.
